(19) United States
(12) Patent Application Publication
(10) Pub. No.: US 2009/0086803 A1
(43) Pub. Date: Apr. 2, 2009

(54) APPARATUS AND METHOD FOR DETECTING SIGNALS IN A COMMUNICATION SYSTEM USING MULTIPLE ANTENNAS

(75) Inventors: Seung-Hoon CHOI, Seoul (KR); Sung-Eun PARK, Seoul (KR); Hong-Sil JEONG, Seoul (KR); Jae-Yoel KIM, Suwon-si (KR); Kyeongcheol YANG, Seoul (KR); Dong-Min SHIN, Seoul (KR); Hyo-Jin LEE, Daegu (KR)

Correspondence Address: Jefferson IP Law, LLP, 1730 M Street, NW, Suite 807, Washington, DC, 20036, US

(73) Assignees: SAMSUNG ELECTRONICS CO. LTD., Suwon-si (KR); POSTECH ACADEMY INDUSTRY FOUNDATION, Gyeongsanbuk-do (KR)

(21) Appl. No.: 12/235,795

(22) Filed: Sep. 23, 2008

(30) Foreign Application Priority Data
Oct. 1, 2007 (KR) 2007-0098867

(51) Int. Cl. H04B 3/46

(52) U.S. Cl. 375/227

(57) ABSTRACT

An apparatus and method for detecting a signal in a communication system using multiple antennas are provided. The apparatus includes an optimal orderer for determining an order of signals that are subject to detection, a controller for controlling a parallel successive interference canceller so as to successively detect the signals according to the determined signal detection order, cancel the successively detected signals from a received signal, detect the signals in reverse order of the signal detection order, and cancel the successively detected signals from the received signal, and outputting a last detected signal and the parallel successive interference canceller for successively canceling the detected signals from the received signal according to a control of the controller. Accordingly, the invention provides a signal detection apparatus and method that improve the reliability while reducing the complexity of a communication system using multiple antennas.

### PRIORITY

This application claims the benefit under 35 U.S.C. § 119(a) of a Korean patent application filed in the Korean Intellectual Property Office on Oct. 1, 2007 and assigned Serial No. 2007-98867, the entire disclosure of which is hereby incorporated by reference.

### JOINT RESEARCH AGREEMENT

The presently claimed invention was made by or on behalf of the below listed parties to a joint research agreement. The joint research agreement was in effect on or before the date the claimed invention was made and the claimed invention was made as a result of activities undertaken within the scope of the joint research agreement. The parties to the joint research agreement are Samsung Electronics Co. Ltd. and Postech Academy Industry Foundation.

### BACKGROUND OF THE INVENTION

1. Field of the Invention

The present invention relates to a communication system using multiple antennas. More particularly, the present invention relates to an apparatus and method for detecting signals in a communication system using multiple antennas.

2. Description of the Related Art

Research on next-generation communication systems is being conducted to provide high-speed, high-quality data services. Due to several factors existing in a wireless channel environment, a transmitted signal suffers distortion while passing through a channel before it is received at a receiver. Such factors include multipath interference, fading, shadowing, propagation loss, time-varying noises, interference, etc. The fading phenomenon, which may distort amplitude and phase of a received signal, is the main cause of impeding high-speed data communication in the wireless channel environment. Accordingly, intensive research is being carried out to address the fading phenomenon. In order to transmit data at a high rate, mobile communication systems should minimize any loss caused by characteristics of mobile communication channels, such as the fading phenomenon, and interference between users. One technology proposed to address this problem uses Multiple Input Multiple Output (MIMO) technology.

One of the MIMO technologies includes a Vertical Bell Labs Layered Space-Time (V-BLAST) technology. In the V-BLAST technology, a transmitter transmits different signals via transmit antennas without the need for complex coding, thereby noticeably increasing the data rate. A receiver uses a linear detection scheme or a Successive Interference Cancellation (SIC) scheme to detect received signals. However, although the V-BLAST technology can improve the data rate, it has a lower diversity gain compared with the general Space-Time Coding (STC) technology.

A description will now be made of the linear detection scheme and the SIC scheme.

The linear detection scheme, which is a scheme for detecting signals through the linear combination of received signals, can be classified into a Zero Forcing (ZF) detection scheme and a Minimum Mean Square Error (MMSE) detection scheme.

The ZF detection scheme uses a pseudo inverse matrix of a channel matrix H as a filter coefficient matrix W and the MMSE detection scheme uses a matrix W that minimizes a value of Equation (1), as a filter coefficient matrix.

E{(x−Wy)²} (1)

The filter coefficient matrixes W used for the ZF detection scheme and the MMSE detection scheme can be expressed as Equations (2) and (3), respectively.

ZF:W_{ZF}=(H^{†}H)⁻¹H^{†} (2)

MMSE:W_{MMSE}=(H^{†}H+2σ²I)⁻¹H^{†} (3)

In Equations (2) and (3), H^{†} refers to the Hermitian matrix of H. Meanwhile, a decision statistic vector z is obtained by multiplying a received vector y by a filter coefficient matrix W. Accordingly, a decision statistic vector zᵢ associated with a signal xᵢ transmitted at an i^{th} transmit antenna can be expressed as Equations (4) and (5).

$$\begin{matrix}ZF \text{:} {z}_{i} = {x}_{i} + {w}_{i} n & ( 4 ) \\ MMSE \text{:} {z}_{i} = {w}_{i} {h}_{i} {x}_{i} + {\sum }_{j \neq i} {w}_{i} {h}_{j} {x}_{j} + {w}_{i} n & ( 5 )\end{matrix}$$

In Equations (4) and (5), wᵢ refers to an i^{th} row vector, and hᵢ refers to an i^{th} column vector of H. It is possible to calculate zᵢ using Equations (4) and (5), and determine an i^{th} transmission signal by performing soft decision on the calculated value in a constellation. The linear detection scheme, though it can detect signals using a relatively simplistic approach, may suffer a reduction in channel capacity because it cannot obtain a diversity gain.

The SIC scheme detects signals by repeating an operation of detecting one transmission signal by means of a ZF detector or an MMSE detector, and then canceling (removing) the detected signal from a received signal. The SIC scheme has superior performance compared with the linear detection scheme.

If an (m−1)^{th} signal detected through the SIC scheme is defined as \hat{x}ₘ₋₁, a modified received vector y^{(m)} and a modified channel matrix H^{(m)} can be determined using Equations (6) and (7), respectively.

$$\begin{matrix}{y}^{( m )} = y - {\sum }_{k = 1}^{m - 1} {h}_{k} {\hat{x}}_{k} & ( 6 ) \\ {H}^{( m )} = [ {h}_{m} … {h}_{M} ] & ( 7 )\end{matrix}$$

In addition, the filter coefficient matrix W is updated using Equations (8) and (9).

ZF:W_{ZF}^{(m)}=(H^{(m)}_{₊}H^{(m)})⁻¹H^{(m)}^{†} (8)

MMSE:W_{MMSE}^{(m)}=(H^{(m)}^{^{†}}H^{(m)}+2σ²I)⁻¹H^{(m)}⁺ (9)

After finding z^{(m)}=(z₁^{(m)}, z₂^{(m)}, . . . , z_{M-m+1}^{(m)})=W^{(m)}y^{(m)} using the foregoing equations, the SIC scheme extracts an m^{th} detected signal. Thereafter, the detection scheme successively detects all transmission signals through an iterative process of canceling the detected signal and updating W in the same manner.

Every time the detection apparatus cancels a signal through the SIC scheme, it can obtain a greater diversity gain. Such a diversity gain d can be expressed as Equation (10).

d=N−M+i (10)

In Equation (10), the variable i refers to the number of detected signals. More specifically, Equation (10) shows that as the number of signals canceled from the received signal increases, a diversity gain obtainable through detection on the remaining signals also increases.

However, even the SIC scheme has disadvantages. When the detection scheme successively cancels the detected signal from the received signal, the entire performance of the system undergoes a significant change according to which signal is first canceled. In other words, in the SIC scheme, if the previously detected signal is a correct signal, a diversity gain can occur when the next signal is detected. However, if the previously detected signal is not a correct signal, an error propagation problem may occur. Therefore, in order to improve the system performance, there is a need for an optimal ordering process for determining the detection order according to a characteristic of the channel matrix H. The typical optimal ordering scheme includes a scheme of detecting a signal in descending order of a Signal-to-Noise Ratio (SNR) and canceling the detected signal from the received signal. The SNR of an i^{th} signal can be expressed as Equations (11) and (12) for the ZF detection scheme and the MMSE detection scheme, respectively.

$$\begin{matrix}ZF \text{:} {SNR}_{i} = \frac{{\vert {x}_{i} \vert}^{2}}{E [ {‖ {w}_{i} n ‖}^{2} ]} & ( 11 ) \\ MMSE \text{:} {SNR}_{i} = \frac{{‖ {w}_{i} {h}_{i} {x}_{i} ‖}^{2}}{E [ {‖ {w}_{i} n ‖}^{2} + ‖ {\sum }_{j \neq i} {w}_{i} {h}_{j} {x}_{j} ‖ ]} & ( 12 )\end{matrix}$$

In Equations (11) and (12), wᵢ is updated every time a signal is detected.

In order to address the above-stated error propagation problem, combined detection scheme schemes using Maximum Likelihood (ML) and Successive Interference Cancellation (SIC) have been proposed. Theses schemes exponentially increase in complexity with an increase in modulation order, but can reduce error propagation through iterative detection.

With reference to Table 1, a description will now be made of an iterative detection scheme based on the ZF detection scheme. Table 1 considers a system having 4 transmit antennas and 4 receive antennas. In Table 1, ŝⱼⁱ refers to a (j+1)^{th} transmission signal which is detected in an (i+1)^{th} step.

TABLE 1

| | Detection Process | |
|---|---|---|
| Detection Order | in Each Step | Last Detected Signal |
| Step 1 | ŝ₃⁰ → ŝ₂⁰ → ŝ₁⁰ → ŝ₀⁰ | ŝ₀ |
| Step 2 | ŝ₀ → ŝ₃¹ → ŝ₂¹ → ŝ₁¹ | ŝ₁ |
| Step 3 | ŝ₀, ŝ₁ → ŝ₃² → ŝ₂² | ŝ₂ |
| Step 4 | ŝ₀, ŝ₁, ŝ₂ → ŝ₃³ | ŝ₃ |

In Step 1 of Table 1, a receiver first detects ŝ₃⁰, and cancels the detected ŝ₃⁰ from the entire received signal according to the optimal ordering. Next, the receiver detects ŝ₂⁰ from the ŝ₃⁰-canceled entire received signal, and cancels the detected ŝ₂⁰ from the ŝ₃⁰-canceled entire received signal. Next, the receiver detects ŝ₁⁰ from the ŝ₃⁰,ŝ₂⁰-canceled entire received signal, and cancels the detected ŝ₁⁰ from the ŝ₃⁰,ŝ₂⁰-canceled entire received signal. Finally, only the ŝ₀⁰ remains in the entire received signal, and the receiver determines the ŝ₀⁰ as the last detected signal ŝ₀.

In Step 2, the receiver first cancels the ŝ₀, which was determined as the last detected signal in Step 1, from the entire received signal, detects signals in order of ŝ₃¹→ŝ₂¹→ŝ₁¹, and cancels the detected signal components from the previous entire received signal. The receiver determines ŝ₁ as the last detected signal. Similarly, in Step 3 and Step 4 the receiver preferentially cancels the signals, which were determined as the last detected signals in the previous steps, from the entire received signal, and then detects the signals by applying the SIC scheme.

The above-stated iterative detection scheme exploits the fact that the last detected signal is highest in reliability. That is, the receiver always finally detects its desired signal through iterative detection so that all signals can obtain the maximum diversity gain. However, even in the iterative detection scheme, if the first detected signal ŝ₃⁰ is low in reliability, it may exert a negative influence on the signal detection of the next step.

### SUMMARY OF THE INVENTION

An aspect of the present invention is to address at least the above-mentioned problems and/or disadvantages and to provide at least the advantages described below. Accordingly, an aspect of the present invention is to provide a signal detection apparatus and method for improving reliability in a communication system using multiple antennas.

Another aspect of the present invention is to provide a signal detection apparatus and method for reducing complexity in a communication system using multiple antennas.

According to one aspect of the present invention, a method for detecting a signal in a communication system using multiple antennas is provided. The method includes (a) determining an order of signals that are subject to detection, (b) successively detecting the signals according to the determined signal detection order, and inversely detecting the signals considering a last detected signal as a first detected signal, (c) successively detecting the signals in reverse order of the determined signal detection order and inversely detecting the signals considering a last detected signal as a first detected signal (d) determining a noise variance value for each of the signals detected in steps (b) and (c), and (e) finding a last detected signal by comparing the noise variance values determined in step (d) with each other.

According to another aspect of the present invention, a method for detecting a signal in a communication system using multiple antennas is provided. The method includes (a) determining a first order of signals that are subject to detection, (b) successively detecting the signals according to the determined first signal detection order and canceling the successively detected signals from a received signal to detect a first of the signals, (c) successively detecting the signals in reverse order of the first signal detection order determined in step (a), with the first signal excluded, and canceling the successively detected signals from the first signal to detect a second of the signals, (d) calculating a first noise variance value depending on the second signal; (e) determining a second order of signals that are subject to detection in reverse order of the first signal detection order, (f) successively detecting the signals according to the second signal detection order determined in step (e), and canceling the successively detected signals from the received signal to detect a third of the signals, (g) successively detecting the signals in reverse order of the second signal detection order determined in step (e), with the third signal excluded, and canceling the successively detected signals from the third signal to detect a fourth of the signals, (h) calculating a second noise variance value depending on the fourth signal, (i) comparing the first noise variance value with the second noise variance value and (j) determining the second signal as a last detected signal when the first noise variance value is less than or equal to the second noise variance value. The steps (a) through (d) and the steps (e) through (h) are performed in parallel.

According to further another aspect of the present invention, an apparatus for detecting a signal in a communication system using multiple antennas is provided. The apparatus includes an optimal orderer for determining an order of signals that are subject to detection, a controller for controlling a parallel successive interference canceller so as to successively detect the signals according to the determined signal detection order, successively cancel the detected signals from a received signal, successively detect the signals in reverse order of the signal detection order, and cancel the successively detected signals from the received signal, and for outputting a last detected signal and the parallel successive interference canceller for successively canceling the detected signal from the received signal according to a control of the controller.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will become more apparent from the following detailed description when taken in conjunction with the accompanying drawings in which:

FIG. 1 is a flowchart illustrating an improved parallel signal detection process according to an exemplary embodiment of the present invention;

FIG. 2 is a block diagram illustrating an improved parallel signal detection apparatus according to an exemplary embodiment of the present invention; and

FIG. 3 is a graph illustrating a comparison in performance between the improved parallel signal detection according to an exemplary the present invention and the conventional signal detection.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention provide a signal detection apparatus and method for improving reliability in a communication system using multiple antennas. The term ‘signal detection with improved reliability’ will be referred to herein as ‘improved parallel signal detection’.

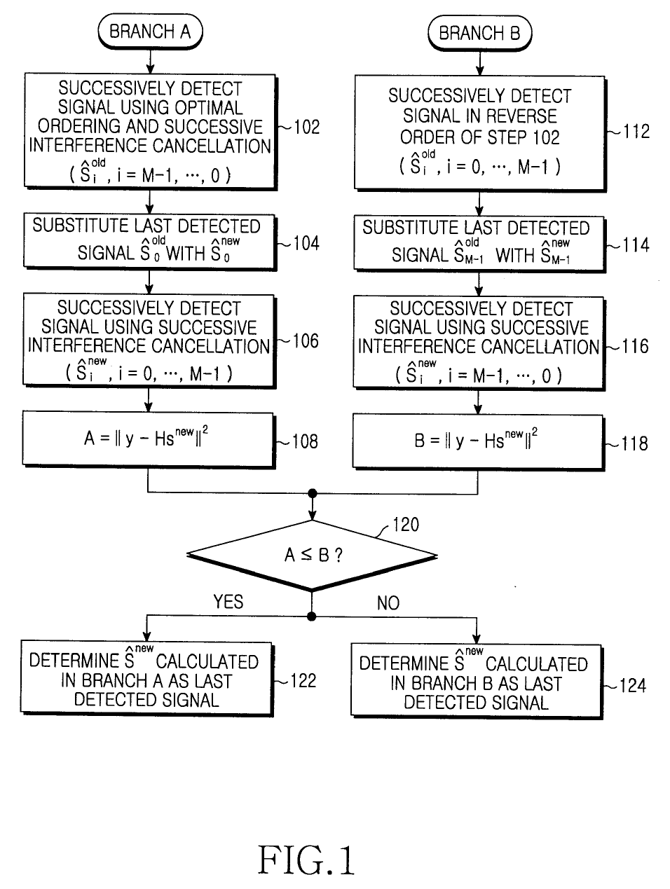

FIG. 1 is a flowchart illustrating an improved parallel signal detection process according to an exemplary embodiment of the present invention.

Referring to FIG. 1, the improved parallel signal detection process is divided into branch A and branch B. Processes of branch A and branch B are performed in parallel. However, for convenience, a description of the process of branch A is herein followed by a description of the process of branch B.

In step 102 of branch A, a receiver successively detects signals Ŝ_{M-1}^{old},Ŝ_{M-2}^{old}, . . . ,Ŝ₁^{old},Ŝ₀^{old} using optimal ordering and Successive Interference Cancellation (SIC) schemes. The optimal ordering scheme may determine a detection order using Equations (11) and (12), and the detection order is assumed herein to be M−1, M−2, . . . , 1, 0. In addition, Ŝᵢ^{old} refers to the first-detected i^{th} transmission signal. In step 104, the receiver substitutes the last detected signal Ŝ₀^{old} with Ŝ₀^{new}. Herein, Ŝ₀^{new} refers to an updated i^{th} transmission signal. In step 106, the receiver successively detects signals Ŝ₀^{new}, Ŝ₁^{new}, . . . ,Ŝ_{M-2}^{new},Ŝ_{M-1}^{new} in reverse or inverse order of step 102. The reason for detecting signals in reverse order of step 102 is because the last detected signal Ŝ₀^{old} is higher in reliability than the first detected signal Ŝ_{M-1}^{old}. Therefore, in step 106, after substituting the signal Ŝ₀^{old} with the signal Ŝ₀^{new}, the receiver updates the signals in reverse order. In step 108, the receiver determines ∥y−Hŝ^{new}∥² and stores the result as parameter A.

Meanwhile, in step 112 of branch B, the receiver successively detects signals Ŝ₀^{old},Ŝ₁^{old}, . . . ,Ŝ_{M-2}^{old},Ŝ_{M-1}^{old} in reverse order of step 102 using the optimal ordering and SIC schemes. In step 114, the receiver substitutes the last detected signal Ŝ_{M-1}^{old} with Ŝ_{M-1}^{new}. In step 116, the receiver successively detects signals Ŝ_{M-1}^{new},Ŝ_{M-2}^{new}, . . . ,Ŝ₁^{new},Ŝ₀^{new} in reverse order of step 112. In step 118, the receiver determines ∥y−Hŝ^{new}∥² and stores the result as parameter B. The result values, determined and stored respectively as parameter A and parameter B in steps 108 and 118, represent noise variance values.

In step 120, the receiver determines if parameter A's value is less than or equal to parameter B's value. If it is determined that parameter A's value is less than or equal to parameter B's value, the receiver determines, in step 122, the signal Ŝ^{new} found in branch A as the last detected signal. However, if parameter A's value exceeds parameter B's value, the receiver determines, in step 124, the signal Ŝ^{new} found in branch B as the last detected signal.

As described above, in the improved parallel signal detection method according to an exemplary embodiment of the present invention, even though one branch fails in interference cancellation, another branch may succeed in interference cancellation, making it possible to improve system performance. In addition, the improved parallel signal detection method can prevent performance degradation caused by error propagation. This is because the two branches A and B are different from each other in their first detected signal. If the first signal is correctly detected in either of the two branches, reliability of the signal detected in the corresponding branch increases, so there is a high probability that the detected signal will be selected as the last detected signal.

In a communication system using the Vertical Bell Labs Layered Space-Time (V-BLAST) scheme, the calculation of a pseudo inverse matrix is complex and therefore occupies a very large portion of the overall computation process. However, in the improved parallel signal detection scheme according to an exemplary embodiment of the present invention, even though signals are detected in parallel, since the pseudo inverse matrixes used in the two branches are equal, there is no need for additional calculation for the pseudo inverse matrixes. For example, for a V-BLAST communication system with 4 transmit/receive antennas, the types of pseudo inverse matrixes necessary for the improved parallel signal detection scheme according to an exemplary embodiment of the present invention can be expressed as Table 2.

TABLE 2
H = (h₁, h₂, h₃, h₄) → W = (H^{†}H)⁻¹H^{†}

| Detected | | Detected | |
|---|---|---|---|
| Signal | Branch 1 | Signal | Branch 2 |
| Ŝ₃^{old} | (h₀ h₁ h₂ h₃) → W₀₁₂₃ | Ŝ₀^{old} | (h₀ h₁ h₂ h₃) → W₀₁₂₃ |
| Ŝ₂^{old} | (h₀ h₁ h₂) → W₀₁₂ | Ŝ₁^{old} | (h₁ h₂ h₃) → W₁₂₃ |
| Ŝ₁^{old} | (h₀ h₁) → W₀₁ | Ŝ₂^{old} | (h₂ h₃) → W₂₃ |
| Ŝ₀^{old} | (h₀) → W₀ | Ŝ₃^{old} | (h₃) → W₃ |
| Ŝ₁^{new} | (h₁ h₂ h₃) → W₁₂₃ | Ŝ₂^{new} | (h₀ h₁ h₂) → W₀₁₂ |
| Ŝ₂^{new} | (h₂ h₃) → W₂₃ | Ŝ₁^{new} | (h₀ h₁) → W₀₁ |
| Ŝ₃^{new} | (h₃) → W₃ | Ŝ₀^{new} | (h₀) → W₀ |

As shown in Table 2, it can be appreciated that even though branch 1 and branch 2 use different detected-signal orders, they use the same type of pseudo inverse matrix.

In this way, in the improved parallel signal detection scheme according to an exemplary embodiment of the present invention, two detection processes are performed in parallel, but they share pseudo inverse matrix calculation, thus making it possible to reduce the complexity compared with the conventional iterative detection scheme.

Table 3 shows a comparison in calculation complexity between the improved parallel signal detection scheme proposed by an exemplary embodiment of the present invention, the conventional ZF-SIC scheme, and the iterative detection scheme.

TABLE 3

| | Number of Pseudo Inverse Matrix |
|---|---|
| Detection Scheme | Calculations |
| ZF-SIC | m |
| Iterative Detection | $\frac{( m + 1 ) m}{2}$ |
| Improved Parallel Signal Detection | 2m − 1 |

As shown in Table 3, it can be appreciated that the improved parallel signal detection scheme according to an exemplary embodiment of the present invention requires more calculations than the conventional ZF-SIC scheme, but fewer calculations than the iterative detection scheme.

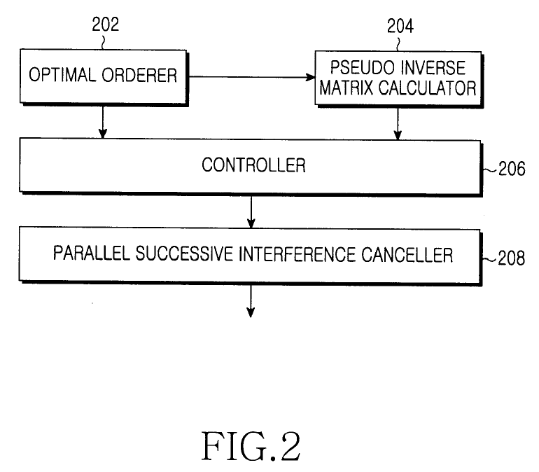

FIG. 2 is a block diagram illustrating an improved parallel signal detection apparatus according to an exemplary embodiment of the present invention.

Referring to FIG. 2, the improved parallel signal detection apparatus includes an optimal orderer 202, a pseudo inverse matrix calculator 204, a controller 206, and a parallel successive interference canceller 208.

The optimal orderer 202 determines an order of signals detected from N received values. That is, the optimal orderer 202 determines the order of signals that it will detect through optimal ordering. The optimal orderer 202 can also determine an order of signals that it will randomly detect. Herein, the N received values refer to the signals which are received by N receive antennas.

The pseudo inverse matrix calculator 204 calculates a pseudo inverse matrix based on the determined detected-signal order using Equations (8) and (9).

The controller 206 detects signals taking into account the detected-signal order information and the calculated pseudo inverse matrix, received from the optimal orderer 202 and the pseudo inverse matrix calculator 204, and controls the parallel successive interference canceller 208. That is, the controller 206 controls the parallel successive interference canceller 208 to parallel-cancel the signals detected from the received signal.

Meanwhile, as for the noise variance values, a separate noise variance value determiner (not shown) can determine them, or the controller 206 can determine them.

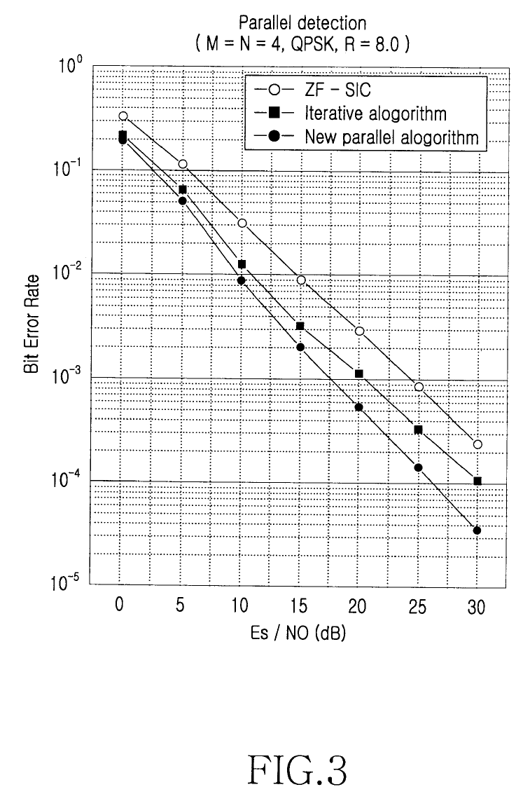

FIG. 3 is a graph illustrating a comparison in performance between the improved parallel signal detection according to an exemplary embodiment of the present invention and the conventional signal detection.

The experimental environment of FIG. 3 considers that the number of transmit/receive antennas is 4. As illustrated in the graph, it can be appreciated that the parallel signal detection scheme according to an exemplary embodiment of the present invention decreases in error propagation due to a diversity gain of the first detected signal, thus increasing its performance compared with the conventional signal detection scheme.

As is apparent from the foregoing description, exemplary embodiments of the present invention can detect signals with improved reliability in a communication system using multiple antennas. The parallel signal detection scheme according to exemplary embodiments of the present invention can detect signals with lower complexity compared with the conventional iterative signal detection scheme.

While the invention has been shown and described with reference to exemplary embodiments thereof, it will be understood by those skilled in the art that various changes in form and details may be made therein without departing from the spirit and scope of the invention as defined by the appended claims and their equivalents.

What is claimed is:

1. A method for detecting a signal in a communication system using multiple antennas, the method comprising:
(a) determining an order of signals that are subject to detection;
(b) successively detecting the signals according to the determined signal detection order and inversely detecting the signals considering a last detected signal as a first detected signal;
(c) successively detecting the signals in reverse order of the determined signal detection order and inversely detecting the signals considering a last detected signal as a first detected signal;
(d) determining a noise variance value for each of the signals detected in steps (b) and (c); and
(e) determining a final detected signal by comparing the noise variance values determined in step (d) with each other.

2. The method of claim 1, further comprising:
updating a pseudo inverse matrix at every signal detection.

3. The method of claim 1, wherein the determining of the signal detection order comprises determining a descending order of a Signal-to-Noise Ratio (SNR) of each of the signals subject to detection.

4. The method of claim 1, wherein the determining of the signal order comprises determining a channel state.

5. The method of claim 4, wherein the determining of the channel state comprises determining an SNR.

6. The method of claim 1, wherein the determining of the signal order comprises randomly determining the signal order.

7. The method of claim 2, wherein the pseudo inverse matrixes used in steps (b) and (c) are equal.

8. An apparatus for detecting a signal in a communication system using multiple antennas, the apparatus comprising:
an optimal orderer for determining an order of signals that are subject to detection;
a controller for controlling a parallel successive interference canceller so as to successively detect the signals according to the determined signal detection order, successively cancel the detected signals from a received signal, successively detect the signals in reverse order of the signal detection order, and cancel the successively detected signals from the received signal, and for outputting a final detected signal; and
the parallel successive interference canceller for successively canceling the detected signal from the received signal according to a control of the controller.

9. The apparatus of claim 8, further comprising:
a pseudo inverse matrix calculator for updating a pseudo inverse matrix at every signal detection.

10. The apparatus of claim 8, wherein the controller detects the signals in descending order of a Signal-to-Noise Ratio (SNR) of each of the signals subject to detection.

11. The apparatus of claim 8, wherein the controller calculates a noise variance value using a received signal, a detected signal, and a channel matrix.

12. The apparatus of claim 8, wherein the signal order is determined depending on a channel state.

13. The apparatus of claim 8, wherein the signal order is randomly determined.

14. A method for detecting a signal in a communication system using multiple antennas, the method comprising:
(a) determining a first order of signals that are subject to detection;
(b) successively detecting the signals according to the determined first signal detection order and canceling the successively detected signals from a received signal to detect a first of the signals;
(c) successively detecting the signals in reverse order of the first signal detection order determined in step (a), with the first signal excluded, and canceling the successively detected signals from the first signal to detect a second of the signals;
(d) calculating a first noise variance value depending on the second signal;
(e) determining a second order of signals that are subject to detection in reverse order of the first signal detection order;
(f) successively detecting the signals according to the second signal detection order determined in step (e), and canceling the successively detected signals from the received signal to detect a third of the signals;
(g) successively detecting the signals in reverse order of the second signal detection order determined in step (e), with the third signal excluded, and canceling the successively detected signals from the third signal to detect a fourth of the signals;
(h) calculating a second noise variance value depending on the fourth signal;
(i) comparing the first noise variance value with the second noise variance value; and
(j) determining the second signal as a last detected signal when the first noise variance value is less than or equal to the second noise variance value;
wherein the steps (a) through (d) and the steps (e) through (h) are performed in parallel.

15. The method of claim 14, wherein the determining of the first order of signals that are subject to detection comprises determining a channel state.

16. The method of claim 15, wherein the determining of the channel state comprises determining an SNR.

17. The method of claim 14, wherein the determining of the first signal order comprises randomly determining the signal order.
